(19) United States
(12) Patent Application Publication
(10) Pub. No.: US 2008/0207433 A1
(43) Pub. Date: Aug. 28, 2008

(54) APPARATUS, METHODS AND PRODUCTS RELATING TO CHEMICALLY BONDED INORGANIC METAL CERAMICS

(76) Inventor: Clement HIEL, Rancho Verdes, CA (US)

Correspondence Address: GILBRETH & ASSOCIATES, P.C., PO BOX 2428, BELLAIRE, TX, 77402-2428, US

(21) Appl. No.: 11/465,121

(22) Filed: Aug. 16, 2006

(51) Int. Cl. C04B 35/00

(52) U.S. Cl. 501/154

(57) ABSTRACT

A chemically bonded ceramic is formed by contacting a Wollastonite component and acid component to form a precursor, which precursor then cured to form the ceramic, with at least one of the components, or precursor cooled to increase the working pot life.

### BACKGROUND

1. Technical Field

This specification relates to ceramics, methods and apparatus for their making, and to products made thereof. In another aspect, the present specification relates to chemically bonded ceramics, methods and apparatus for their making, and to products made thereof. In even another aspect, the present invention relates to chemically bonded inorganic metal ceramics, methods and apparatus for their making, and to products made thereof. In still another aspect, the present invention relates to chemically bonded phosphate ceramics, methods and apparatus for their making, and to products made thereof.

2. Brief Description the Background

Wollastonite is used as the primary material in phosphate cement compositions.

Only few formulations are known in that field so far, they all have quick setting characteristics. Hardening of these compositions usually occurs at ambient condition in a range from about several minutes to about twenty 20 minutes after forming of the cement, which makes it practically-impossible to be used in applications such as that of composite materials, and certainly limiting the size of a product that may be made from the material.

The exothermic release of a large amount of heat production is another typical phenomenon of the traditional phosphate cements, which may produce defects inside of the material and negatively effect material properties. This occurs because there is a fixed amount of energy liberated during curing; the shorter the period of curing, the more energy is released per unit time, and the more the sample is heated.

When wollastonite is employed as primary material in the normally acidic composition, the quick setting may result in extra voids and cracks in structure of the material due to formation and release of CO₂ during the setting process produced by decomposition of calcite (CaCO₃) contained in the wollastonite, which further undermines strength and durability of the material.

A number of patents are directed to inorganic cement compositions, including the following.

Japanese Patent Application No. A-47-2424 (February 1972), proposes a semi-rigid heat insulating refractory comprising neutral magnesium phosphate, an alkaline earth metal oxide, silica, acid oxides other than silica and inorganic fibers and having a density of at most 0.9 g/cc, a melting point of at least 1500 C and a working temperature limit of at least 1200 C.

U.S. Pat. No. 3,804,651 dated Apr. 16, 1974 to C. E. Semler, discloses a quick setting gel binder of phosphate solutions and wollastonite. While the cured binder is disclosed as having good mechanical strength and durability, its fresh mixture gels quickly and is taught as being a quick setting composition.

Japanese Patent Application No. A-51-2727 (January 1976), proposes a process for producing an inorganic building material plate, wherein a green plate obtained by mixing cement with a reinforcing material, a filler, etc., followed by sheeting, is coated with a composition obtained by mixing and reacting three components i.e. phosphoric acid and/or a phosphate, aluminum and/or an aluminum compound and a Group IIA metal and/or a Group IIA metal compound, by itself or together with a proper amount of water, and the plate is then cured.

Japanese Patent Application No. A-55-51768 (April 1980), proposes an inorganic composition for low temperature burning, which is prepared by incorporating a reinforcing material durable against a burning temperature with an upper limit of 750 C, to an inorganic molding material made of a mixture comprising (a) a natural matter or composition, or glass, containing alumina, silica or both as the main component, and (b) phosphoric acid or its salt. As such a reinforcing material, glass fibers, rock wool, metallic fibers, carbon fibers and mixtures thereof, are mentioned.

Japanese Patent Application No. A-55-95667 (July 1980), proposes a construction material comprising a glass fiber-reinforcing material, a copper-chromium-phosphate binder or an aluminum-chromium-phosphate binder and a powder mixture of kaolin and a magnesium-containing inorganic extender, as a neutral active doping agent.

U.S. Pat. No. 4,375,516 dated Mar. 1, 1983 to Jeffery L., Barrall et. al, discloses a material in composition of aluminium phosphate solution and solid component containing wollastonite. This composition too is taught as quick setting, usually setting in several minutes in the temperature range of 4-25 C.

Japanese Patent Application No. B-59-3958 (January 1984), discloses a process for producing a pliable, inorganic, non-combustible molded product, wherein an aqueous slurry mixture prepared by mixing proper amounts of a quick-acting hardener and a slow-acting hardener to an inorganic film forming agent as the main agent, is impregnated in and coated on a shaped fibrous base material such as paper, woven fabric, non-woven fabric or a mat, and then hardened. As the inorganic film forming agent, a metal phosphate such as aluminum phosphate or aluminum polyphosphate, is disclosed. As the hardener, magnesium oxide, zinc oxide, aluminum hydroxide, calcium hydroxide or calcium silicate, is, for example, mentioned. As the fibrous base material, glass fibers are, for example, disclosed.

Japanese Patent Application No. A-60-228142 Nov. 1985), proposes a bonded composite structure comprising at least one layer of at least one type of layer forming material, each layer of the layer forming material being bonded to an adjacent layer by a water resistant phosphate adhesive material obtained by a reaction of a composition comprising a metal oxide, calcium silicate and phosphoric acid. As examples of the layer forming material, woven fabric, non-woven fabric and chopped glass fibers are mentioned.

Japanese Patent Application No. B-61-58420 (December 1986), discloses a method for producing a filled inorganic plastic cement, which comprises mixing a microfiber filler to a reactive aqueous slurry comprising a magnesium salt, a water-soluble phosphate component and magnesium oxide and having a viscosity of from about 700 to 15000 cps, in an amount of from 2 to 40% by weight of the slurry.

U.S. Pat. No. 4,792,359 dated Dec. 20, 1988 to Jeffery L., Barrall et. al, discloses a method to prepare composite materials by hot pressing the mixture of phosphate cement and varies fibres at about 85.degree. C. under pressures, which takes advantage of the quick setting.

JP-A-4-317403 (November 1992) proposes to incorporate an organic liquid buffer, such a carboxylic acid, an amine or urea, into a hardenable composition. However, the carboxylic acid or the amine to be used as the organic liquid buffer, will not evaporate or decompose, and accordingly, will remain in the hardened composition, causing problems.

U.S. Pat. No. 6,103,007, issued Aug. 15, 2000, to Wu et al., discloses inorganic resin compositions with increased pot life, comprising, in combination, an aqueous solution of metal phosphate, an oxy-boron compound added to increase pot life, a wollastonite compound and other optional additives, inorganic composite articles and products reinforced by fillers and fibers including glass fibers obtained from these compositions and processes for preparing said products.

U.S. Pat. No. 6,409,951, issued Jun. 25, 2002, to Inoue et al., discloses a process for producing an inorganic molded product, which comprises a step of preparing a hardenable composition comprising 100 parts by mass of an acid metal phosphate, from 80 to 200 parts by mass of its hardener, and from 0.1 to 10 parts by mass of urea, a step of combining 100 parts by mass of the hardenable composition and from 5 to 100 parts by mass of an inorganic reinforcing material to obtain a molding material, a step of molding the molding material into a desired shape to obtain a semi-rigid material, and a step of heating the semi-rigid material at a temperature of at least 120 C to complete hardening.

However, in spite of the above patents and publications, there still exists a need in the art for technology relating to chemically bonded ceramics.

There exists another need in the art for products, methods and apparatus for making chemically bonded ceramics. This is particularly true for products that comprise fiber reinforced chemically bonded ceramics and the methods that make them.

### SUMMARY OF THE INVENTION

The following presents a general summary of several of the many embodiments of this disclosure in order to provide a basic understanding of at least some of embodiments. This summary is not an extensive overview or exhaustive list of all possible embodiments of the disclosure. It is not intended to identify key or critical elements of the disclosure or to delineate the scope of the claims. The following summary merely presents some concepts of the disclosure in a general form as a prelude to the more detailed description that follows.

This disclosure provides technology relating to chemically bonded ceramics.

This disclosure provides for products, methods and apparatus for making chemically bonded ceramics.

According to one embodiment there is provided a method which includes cooling at least one of a Wollastonite component or an acid component; and contacting the Wollastonite component and the acid component to form a precursor for a chemically bonded ceramic.

According to another embodiment there is provided a method comprising the steps of contacting a wollastonite component and an acid component to form a precursor; and cooling the precursor.

According to even another embodiment there is provided a method comprising the steps of contacting a wollastonite component and an acid component to form a precursor; and cooling both the wollastonite component and the acid component during at least a portion of the contacting.

Further embodiments of the above method embodiments include curing the precursor to form a chemically bonded ceramic, and/or cooling during at least a portion of the curing.

According to yet another embodiment there is provided a precursor for a chemically bonded ceramic comprising a wollastonite component and an acid component, wherein at least one of the components is cooled.

According to even still another embodiment there is provided a precursor for a chemically bonded ceramic comprising a wollastonite component and an acid component, wherein at least one of the components is cooled.

According to even yet another embodiment there is provided a method for making a composite structure, comprising the steps of applying a release layer to a mandrel, applying a precursor material comprising a wollastonite component and an acid component to the release material, and curing the precursor material to form a cured ceramic.

According to yet even another embodiment there is provided a product comprising a mandrel, release material supported on the mandrel, and precursor material supported by the release material, where the precursor material comprises a wollastonite component and an acid component.

According to yet even another embodiment there is provided a product comprising

a mandrel, release material supported on the mandrel, cured ceramic material supported by the release material, where the cured ceramic material is formed from a wollastonite component and an acid component.

According to even yet another embodiment there is provided a method for making a composite structure, comprising the steps of forming a precursor material comprising a wollastonite component and an acid component and applying to a woven or non-woven textile, knit or mat material, wetting out and fully impregnating the fibrous material while removing volatile gases, placing the fibrous reinforced precursor onto a molding surface, curing the fiber reinforced precursor material to form a cured fiber reinforced ceramic, and removing the cured ceramic part from the molding surface.

According to yet even another embodiment there is provided a product comprising forming a precursor material comprising a wollastonite component and an acid component and applying to a woven or non-woven textile, knit or mat material, wetting out and fully impregnating the fibrous material while removing volatile gases, placing the fibrous reinforced precursor onto a molding surface, curing the fiber reinforced precursor material to form a cured fiber reinforced ceramic, and removing the cured ceramic part from the molding surface.

Even further embodiments of all of the above embodiments include those in which acid component comprises aqueous phosphoric acid, and the Wollastonite component comprises a Wollastonite powder.

Still further embodiments of all of the above embodiments include those in which the precursor component may or may not include reinforcement materials, such as fibrous, woven or other type of reinforcing material.

Yet further embodiments will become apparent to those of skill in the art upon review of this disclosure, and those embodiments are also considered to be part of this disclosure.

### BRIEF DESCRIPTION OF THE DRAWINGS

FIG. 1 is a temperature-time curve which was obtained when mixing phosphate cement at room temperature.

FIG. 2 is a temperature-time curve which was obtained when mixing phosphate cement, in which the components were first cooled prior to mixing, and the mixing then carried out in a cooled mixing station.

FIG. 3 is a schematic showing a non-limiting example of one embodiment of cooling station 100, showing freezer 10 having an opening 18 that was cut into the top lid 14, showing plastic tank 15 placed into the opening 18, insulating bags 22, thermostat 21, and outlet line 25.

FIG. 4 is a side end view of mandrel assembly 40 prior to application of resin, showing mandrel 41, resilient members 43, release member 45, and a pulling ring 47.

FIG. 5 shows piece of paper 51 which defines the 3-dimensional surface on which the thin fibrous material has to glide in order to be converted into a thin rectangular cross-section which is wrapped around mandrel 41.

FIGS. 6, 7 and 8, there are shown a side view, cross-sectional view and enlarged sectional view of a theoretical tower design 200 having a number of modular connectable sections 210, 220, 230, and 240.

FIG. 9 is a cross-sectional view of an open cell sandwich panel design.

FIG. 10 is a graph of load deflection which was obtained by steadily increasing the load at 900 lb/min (4090 N/min) until the sandwich panel failed.

FIG. 11 is a graph of deflection as vacuum was increased, with the hysteresis-loops due to leakages which are sealed during the course of the test.

FIGS. 12 and 13 are graphs of comparative beam strength before and after heat exposure.

### DETAILED DESCRIPTION OF THE INVENTION

The present disclosure provides methods for making a hardenable inorganic resin composition, and methods for making various products from any number of inorganic resin compositions. In general, those methods may include one or more of the step of combining various components into a hardenable composition, the step of forming the hardenable composition into the desired product precursor, which step of forming may include combining the hardenable composition with other additive(s) and/or physical substrate(s), and the curing of the product precursor to form the desired product.

The combining of the various components to form the hardenable inorganic resin compositions of the present invention results in an exothermic curing reaction that will increase the temperature of the resulting hardenable inorganic resin composition. As discussed above, the working life of such hardenable compositions is relatively short, especially when the composition is to undergo timely working steps. As curing progresses, there becomes a point at which the composition viscosity is sufficiently high that the composition is no longer easily or practically workable.

According to the present disclosure, a cooling step may be employed to increase the working life and allow for a longer working period of the hardenable composition, and/or to allow for control over the cure rate of the hardenable composition.

Overview of Cooling Step

When the various components of the hardenable inorganic resin composition are combined, the composition temperature starts out at an initial temperature, and in the absence of any cooling, the composition temperature will rise above the initial temperature due to the exothermic nature of the curing process, and approach an asymptote as curing approaches completion. Of course, it should be understood, the curing curve of composition temperature versus time will vary from composition to composition. Using this composition temperature as an indication of curing progress, there is a maximum working temperature between the initial temperature and the asymptote temperature at which the composition is no longer practically workable.

Certainly, cooling is employed to reduce the curing rate of the hardenable composition and thus increase the working life of the hardenable composition. This may be accomplished by employing cooling to delay the approach of the composition temperature to the maximum working temperature.

It should be understood that cooling may be applied at any point in the making of the hardenable inorganic resin composition, and in making the various products from the composition.

As non-limiting examples, this cooling step may include cooling any or all of the components of the hardenable composition before or during combing, cooling the components in the hardenable composition, the cooling of any or all materials that may be added to the formed hardenable composition, the cooling of any substrate to which the hardenable composition may be applied, the cooling of the hardenable composition and/or substrate during the forming of the hardenable composition into the product precursor, and/or the cooling of the product precursor.

Combining Various Components into a Hardenable Composition

The methods of the present disclosure are believed to have applicability to any number of inorganic resin compositions. A non-limiting example of suitable resin compositions includes any suitable inorganic metal resin compositions, non-limiting examples of which include inorganic metal phosphate resin compositions. Non-limiting examples of suitable inorganic metal phosphate resin compositions and methods for making, and methods for making products therefrom, are disclosed in U.S. Pat. Nos. 6,103,007 and 6,409,951, both herein incorporated by reference for all that they disclose and teach.

The components of suitable inorganic metal phosphate resin compositions include a metal phosphate component and a calcium silicate component, and may include any other components as desired. The inorganic resins of the present invention are formed basically by reactions between the phosphate component and the calcium silicate component, either physically separated or mixed or in combination thereof.

As a non-limiting examples, suitable metal phosphate components include an aqueous solution of metal phosphate preferably selected from the group consisting of aluminium phosphates, zirconium phosphates, magnesium phosphates, zinc phosphates, calcium phosphates, iron phosphates, including derivatives and mixtures thereof. It should be understood that the term solution of the metal phosphate is used broadly herein to include aqueous reaction mixtures, and the term derivative of metal phosphates herein includes all types of phosphate such as polyphosphate, mono and dihydrogen phosphate pyrophosphate and the like.

As a non-limiting example, suitable calcium silicate components include wollastonite including natural and synthetic wollastonite, in calcined or non-calcined state.

The hardenable resin composition may optionally include any other additives as desired, non-limiting examples of which include colorants, cross-linking agents, natural or synthetic polymeric fibers, metallic fibers, fillers, glass particles or spheres, microballons of glass or polymer, processing aids, reinforcing agents, viscosity and thixotropy control agents, water soluble polymers, minerals including talc, mica, clay, basalt, sand, aggregate mixtures, diatomaceous earth, or blends and combinations thereof. These other additives may be added as components to form the hardenable resin composition, or may be added to the hardenable resin composition after it is formed. Fibrous reinforcements for the chemically bonded ceramic are of particular interest and can include but are not limited to natural or synthetic fibers or either organic or inorganic origin. These fibrous reinforcements can be used in a variety of forms including chopped fibers, chopped mat, continuous strand mat, woven or knitted textiles, felts and other non-woven textile forms, or combinations of these. The fibrous reinforcement is advantageously present in weight percents of 1 to 50 weight percent, more advantageously from 2 to 40 weight percent, and most advantageously from 5 to 30 weight percent.

Regarding color, the natural color of the wollastonite/phosphoric acid combination is white. Certainly, any desired color can be achieved by mixing a pigment, paint, or ink into the liquid. While the range may vary, for most colors, typically 2% to 5% by weight is enough to achieve a deep color. As such one can create the color of wood or brick as needed for the application.

The hardenable inorganic resin composition may be formed, generally by combining the metal phosphate component and the calcium silicate component, and any other additives. According to various embodiments of the present disclosure, any or all of the metal phosphate component, the calcium silicate component, and other additives may be subjected to cooling.

Forming the Hardenable Composition into the Desired Product Precursor

Once the hardenable inorganic resin composition has been formed, it may be formed into any desired product. Techniques for forming a resin composition into a desired product are well known, and any suitable technique may be employed, including batch, semi-continuous, and continuous processes such as extrusion, impregnation, filament winding, molding, pressing, pultrusion, stamping, winding, and wrapping.

According to various embodiments of this disclosure, cooling may be applied at any time during the forming of the desired product precursor.

As a non-limiting example, the hardenable inorganic resin composition may be formed into a desired product and cured, or may be combined with a suitable substrate and then cured. In non-limiting embodiments of this disclosure, a mat or fabric is impregnated with hardenable inorganic resin, which mat or fabric may then be formed into a desired product, or combined with other substrates to form a desired product. As a non-limiting example, a fiber glass fabric may be impregnated with resin and then wound around a substrate and then cured to form a desired product.

As another non-limiting example, a method wherein a mat-shaped inorganic reinforcing material is used, and the mat-shaped reinforcing material is dipped in a bath of the hardenable composition, and the composition is impregnated and attached to the mat-shaped reinforcing material, while withdrawing the reinforcing material from the bath

As even another non-limiting example, a method wherein the hardenable composition is preliminarily made to have a high viscosity to some extent, and it is coated on the surface of a carrier material such as a resin film; on the coated composition, chopped strands obtained by cutting or preliminarily cutting rovings in a predetermined length, are scattered, followed by compressing by a compressing apparatus via a carrier material, to impregnate the composition to the reinforcing material.

As still another non-limiting example, a method of employing a hand lay up method or a spray lay up method as used for the production of a glass fiber-reinforced plastic, wherein instead of the plastic (resin) the hardenable composition is used.

As yet another non-limiting example, a method wherein as the inorganic reinforcing material, short fiber form inorganic fibers such as whiskers, milled fibers or chopped strands, are used, and the hardenable composition and the inorganic reinforcing material are kneaded by means of a dispersion mixer such as a kneader.

Curing the Product Precursor to Form the Desired Product

Upon the formation of the desired product precursor, the hardenable inorganic resin composition is then allowed to fully cure to form the desired product.

In various non-limiting embodiments of the present invention, cooling may be applied at any time in the curing process. Once the product precursor is formed, it may be desirable to control the cure rate with cooling to maintain product integrity. Under certain circumstances, too rapid of curing may cause structural defects, whereas a controlled curing will reduce formation of structural defects.

### EXAMPLES

The following examples are provided merely to illustrate various non-limiting embodiments or features of the disclosure, and are not meant to in any way limit the scope of the claims attached. Hereto.

### Example 1

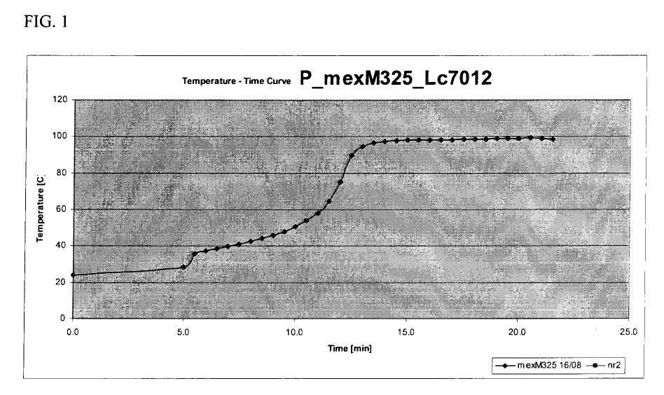

Referring now to FIG. 1, there is shown a temperature-time curve which was obtained when mixing phosphate cement. The mixing of the components starts at room temperature. After mixing an exothermic reaction develops and the temperature of the mixture increases with time. For this particular composition, it is noted that at 35 degrees C., about 5 minutes into the mixing, the mix is no longer workable and has become too thick for the impregnation of glass fiber fabric. Of course, it should be noted that the maximum working temperature will vary for each composition.

### Example 2

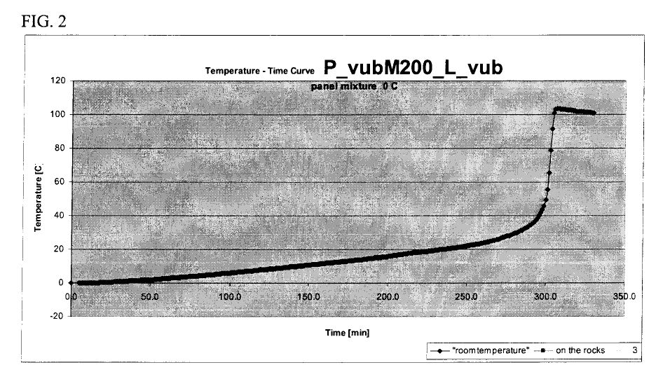

Referring now to FIG. 2, there is shown a temperature-time curve which was obtained when mixing phosphate cement, in which the components were first cooled prior to mixing, and the mixing then carried out in a cooled mixing station. The mixing of the components starts at 0 degrees C. As shown in FIG. 1, after mixing an exothermal reaction develops, however, the rate of temperature increase is much slower. For this particular cooled mixing example, it is noted that the 35 degrees C. point at which the composition is no longer workable is now reached in about 300 minutes into the mixing.

### Example 3

### Cooling Station

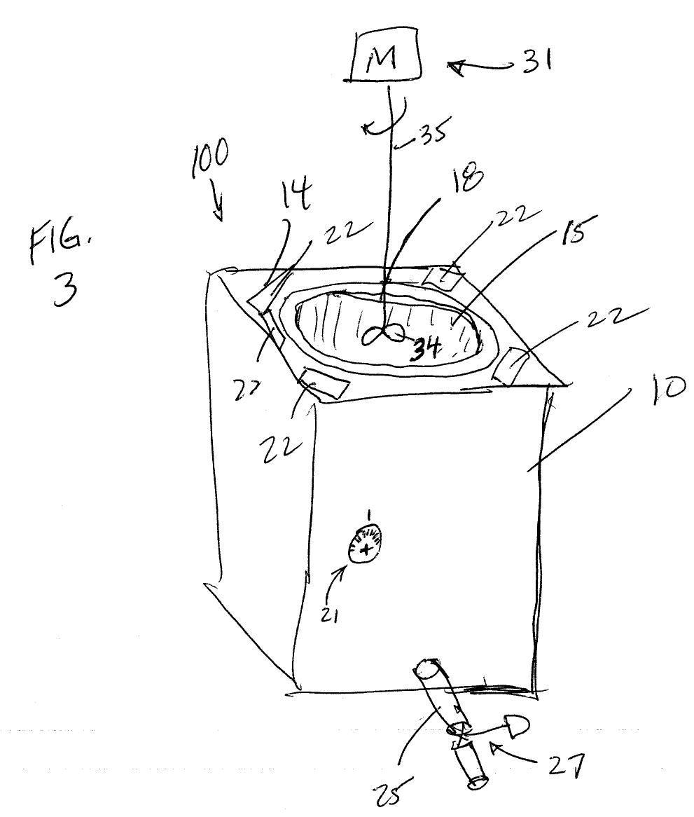

Referring now to FIG. 3, there is shown a schematic of a non-limiting example of one embodiment of cooling station 100. In this non-limiting example, cooling station 100 utilized is basically a freezer 10, which has been modified. An opening 18 was cut into the top lid 14 and a plastic tank 15 was placed into the opening 18. In order to have good heat transfer from the liquid, the tank was surrounded with plastic bags 22 filled with a coolant such as antifreeze. Of course, any suitable heat conductor in any suitable form could be substituted for the coolant filled bags 22. In order to make the freezer operate as a refrigerator optional thermostat 21 was added which is set such that the temperature does not go below 32 F. The main reason for this is to prevent water from condensing into the tank and forming ice. Alternatively, dry air could be purged though the cooling station to eliminate moisture, or desiccants could be utilized. The cool liquid resin can be tapped-off from an outlet 25 by operating a plastic valve 27 at the bottom of the unit which empties the tank. In the non-limiting embodiment as shown, mixer 31 with impeller 34 on the end of rotating shaft 35 is a converted drill press which has been outfitted with a 1 HP motor. Certainly, automation can be implemented for controlling the temperature, liquid level, outlet, mixer and any other function.

### Example 4

### Wrapping Station

As a non-limiting example, the wrapping is done around mandrels. Certainly, any suitable shape of mandrel may be utilized as desired, with suitable cross-sections including any n-sided regular and irregular geometric shapes. The mandrels utilized in this non-limiting example have a rectangular cross-section. While the mandrels may comprise any suitable materials, non limiting examples of which include metal, plastic, wood, composites, ceramics as well as any others. Lighter weight materials will make handling easier. Wood mandrels are utilized in this example.

In other embodiments, a mandrel could be utilized which functions as a mold. As a non-limiting example, a mandrel with concave, flat and/or convex portions could produce a ceramic with a negative shape to form any suitable container having convex, flat or concase portions. Non-limiting examples of such include such as a bake pans, bake plate, multi-cavity items such as a muffin or cup cake pan.

Generally, a thin carbon reinforced polymer tube is preferred for prismatic tower segments because the objective is to achieve higher resonance frequencies (mostly first bending frequencies), which is comparable or higher than for steel towers. One non-limiting example is for an 80 meter tall tower in which the first bending frequency is over 80% higher than that of a steel tower. The weight is only about 22% of that of a steel tower.

For other applications the mandrels may be made of wood, a thermoset, thermoplastic, elastomer, or ceramic resin. These mandrels may or may not be reinforced with fibers. Non-limiting examples of suitable fibers include glassfiber, carbonfiber, Kevlarfiber, natural fibers, etc.

In another non-limiting embodiment, a relatively soft but energy absorbent polymer resin or elastomer composite is surrounded by hard ceramic matrix material that can be made even harder by mixing-in very hard ceramic particles. This hard layer acts as a first layer of defense against local impact i.e. ammunition.

As another non-limiting example, the mandrel resin and fiber architecture could be optimized for energy absorption and find use in a security wall, which needs to sustain blast loads and/or local ammunition impact loads.

There are any number of suitable ways to attach prismatic segments or panels. The attachment may be integral to or added to the mandrel. As non-limiting examples, the mandrel itself can be manufactured by any number of methods, including but not limited to pultrusion, filament winding, resin infusion, or any other manufacturing method applicable for polymer matrix composites.

At the wrapping station, first the mandrel has been wrapped with ceramic matrix composite. These mandrels are assembled as described earlier. After assembly and cure of a prismatic member or panels, it is sufficient to cut through the skin in order to get access to the inside of the attachment pieces which are on both ends of the mandrel. A bolt or pin can then be inserted and multiple pieces and be assembled.

A material to facilitate release of the CBC (chemically bonded ceramic) material may be provided on surface of the mandrel, if release is desired. On some occasions it may be desirable to have the CBC remain permanently bonded to the mandrel, in these cases no release is required. A variety of materials may be applied to the mandrel and function to facilitate release of the CBC. A resilient layer may be utilized to provide some “give” to allow the mandrel to be more easily separated from the CBC. It should be understood that separate layers of resilient material and release materials can be used.

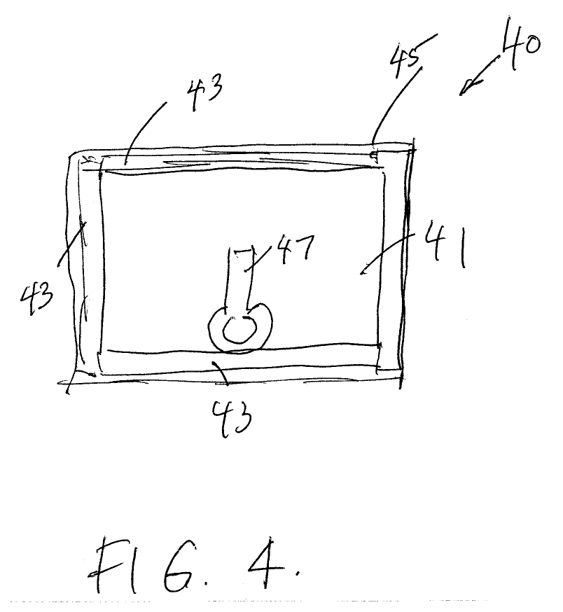

Referring now to FIG. 4, there is shown a side end view of mandrel assembly 40 prior to application of resin, showing mandrel 41, resilient members 43, release member 45, and a pulling ring 47.

Release member 45 has a surface which will facilitate release of the CBC from the mandrel 41. Any suitable material may be utilized, although in this non-limiting example, commercial grade plastic wrap was utilized. Non-limiting examples of suitable film materials include thermoplastics such as polyolefins, especially, any containing, polymers or copolymers of polyethylene (PE), polypropylene (PP), polyvinyl chloride (PVC), polyvinylidene dichloride (PVDC, Saran), and mixtures and copolymers comprising at least one.

Resilient member 43 serves to provide some “give” so that mandrel 41 can be separated from the CBC.

In this non-limiting example, resilient member 43 is Styrofoam which is first taped to the wood mandrel 41. Resilient member 43 may comprises any material which will provide some amount of give to allow mandrel 41 to be separated from the CBC material. Any type of materials that may be described as resilient, rubbery, springy, bouncy, or compressible can be used including hydraulic filled and emptied chambers, tubes, rings, etc. which can also be used to transfer heat into or out of the CBC with the fluid to control cure as desired.

Plastic release member 45 is subsequently wrapped around the Styrofoam resilient member 43. The plastic release member 45 facilitates the release the cured CBC-resin material. Ring 47 allows attachment for pulling on mandrel 41. In the non-limiting embodiment of this example, release member 45 is a commercial grade plastic wrap, with any suitable type of thermoplastic material believed to be suitable. Non-limiting examples of suitable film materials include thermoplastics such as polyolefins, especially, any containing, polymers or copolymers of polyethylene (PE), polypropylene (PP), polyvinyl chloride (PVC), polyvinylidene dichloride (PVDC, Saran), and mixtures and copolymers comprising at least one.

In this non-limiting example, in moving thru the wrapping station, the mandrel moves horizontally, whereas the fibrous material moves off the spool horizontally and is then carried down into an impregnation bath that contains the cooled resin material. As a non-limiting description, the rollers which have internal bearings basically roll the resin into the fibrous cloth or mat or unidirectional material. It should be understood that the woven or non-woven textile, knit, or mat may comprise any suitable material, non-limiting examples of which include glass fiber, carbon fiber, Kevlar, fibers of polyethylene (PE), polypropylene (PP), polyamide (PA, nylon), polyethyleneterephthalate (PET, polyester), polyacrylonitrile (PAN), poly(meth)acrylate, metal fibers, natural fibers, and combinations thereof or so called hybrids.

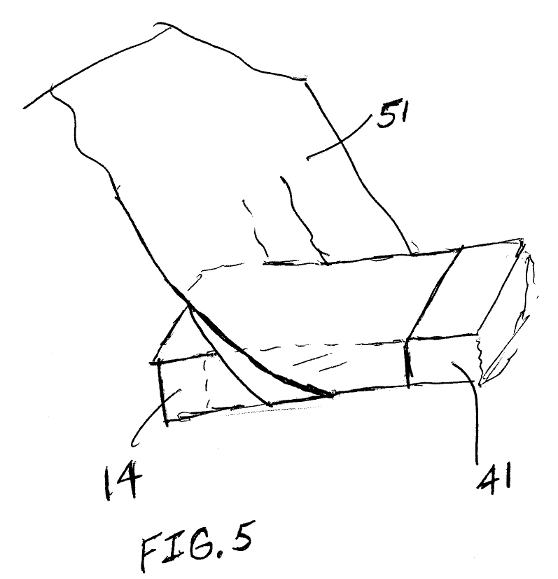

As the mandrel proceeds, the impregnated fabric or mat is automatically wrapped around the mandrel preferably in such an manner as to minimize or have no wrinkles. As a non-limiting example, one way that this may be accomplished is by assuring that as a thin cross-section of the fibrous material comes off the roll, that same cross section ends up as a rectangle wrapped around the mandrel. This is made more possible if the travel lengths between both cross-sections are at least nearly if not identical. This defines the 3-dimensional surface which can be shown in FIG. 5 by means of a piece of paper 51 on which the thin fibrous material has to glide in order to be converted into a thin rectangular cross-section which is wrapped around mandrel 41.

The two other figures above show the mandrels in different stages of progression through the wrapping unit.

### Example 5

### Sandwich Panel Assembly and Molding Station

This non-limiting example describes the various stages of one embodiment to obtain a sandwich panel with long term (4 hour) fire resistance capacity at 1200 C.

First a skin layer is laid onto the mold surface. When working with CBC resins such as inorganic chemically bonded phosphate ceramics, the choice of mold material is very important. A number of plastics, especially polyolefins comprising polyethylene, polypropylene, PVC, Saran and copolymers and blends will have the release properties needed to release CBC off the mold surface after drying. Other appropriate materials are borosilicate glass, highly polished ceramic and metal alloys which are qualified for contact with phosphoric acid such as Hastelloy 22 and nickel alloys.

Once the bottom skin has been laid onto the mandrel and impregnated, then the mandrels are laid side by side onto the wet skin layer. These mandrels also have been wet impregnated and they form a primary bond with the skin as they cure.

During the placement of the mandrel, other impregnated fibers are added to the layup. In the making of firewalls, fire resistance is increased markedly when adding unidirectional carbon fibers.

When the wrapped mandrels are in place, the top skin of the sandwich panel is laid over the mandrels and impregnated with the CBC resin. The bottom of the upper mold half also has good release properties and is therefore polypropylene, polyethylene, PVC, Saran, or borosilicate glass, highly polished ceramic and metal alloys which are qualified for contact with phosphoric acid such as Hastelloy 22 and nickel alloys.

A good release was obtained by using a “peel ply.” This is a woven material, as a non-limiting example shade cloth was utilized, that has been surface treated such that the surface tension is lowered This means that dirt and other foreign materials will not easily stick to it. When used in the present invention, the “peel ply” allows for excess resin and excess air to come up and escape from the laminate providing a higher quality laminate with fewer flaws, cracks, voids, fractures or imperfections. Pressure is applied to the top half of the mold.

Depending upon the material selected, the shade cloth may create a certain surface texture. As a non-limiting example, any polymer grid, laid into the mold will leave an imprint in the mold surface. If this polymer grid is later pulled out of the mold surface it will leave grooves. These grooves could give the appearance of brick to the wall panels to the prismatic segments. Alternatively a mold surface could have the texture of wood (i.e. it could be machined into a PVC or polypropylene plate) that would then be transferred to the flat or prismatic parts.

### Example 6

### Panel Demolding and Mandrel Extraction Station

When taking the panel out of the mold, the peel ply is pulled off the top surface and discarded. The surface now has the texture of the peel ply, which can be rough or fine, depending on the weave of this ply.

Because of the wrapping with a resilient material such as the Styrofoam the mandrels can easily be extracted. Once the mandrel is removed, the resilient material is usually pulled easily out of the cavities and in depending upon its condition may be reused. Once the foam has been pulled out, the wrapping material can be pulled loose from the CBC composite and is then usually discarded as it is probably not in condition to be reused.

It should be understood that the present disclosure contemplates products in which the mandrels are not removed, but rather are kept in place as a reinforcement.

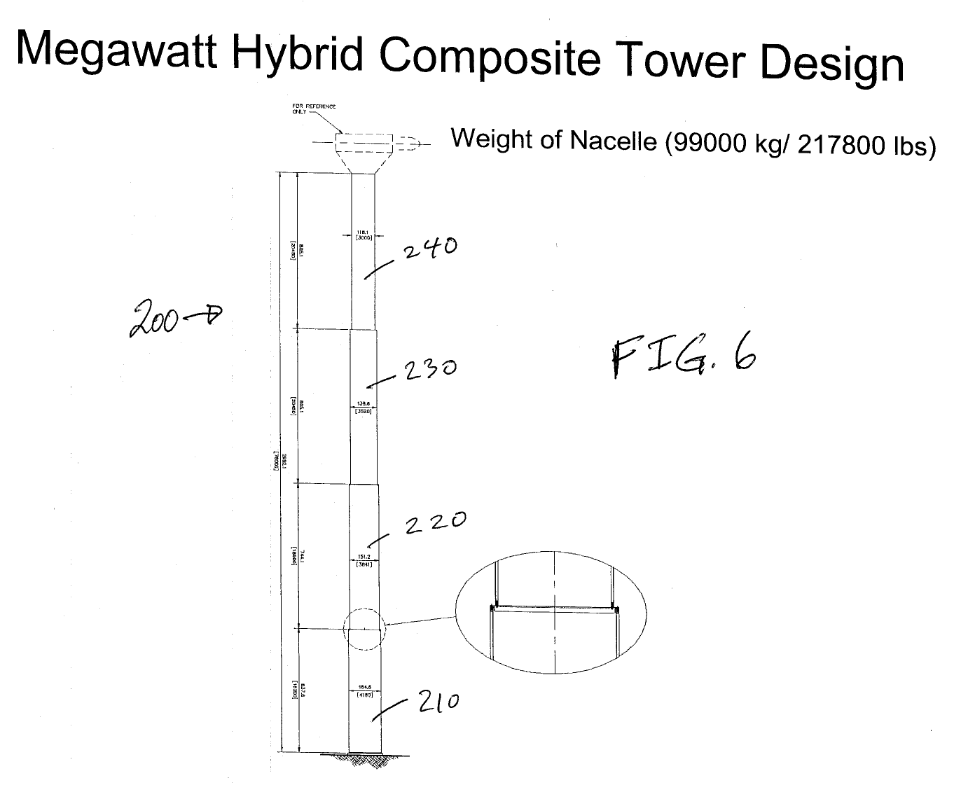

Referring now to FIGS. 6, 7 and 8, there are shown a side view, cross-sectional view and enlarged sectional view of a theoretical tower design 200 having a number of sections 210, 220, 230, and 240.

Each of sections the tower sections 210, 220, 230 and 240 is similar with the differences residing in the dimensions of each section. For this non-limiting example, the number of ribs decreases from 100, then to 92, then to 84 and finally to 70 for sections 210, 220, 230 and 240.

### Example 7

### Sandwich Panel

The present disclosure also provides for panels for a high-performance-firewall which is capable of separating expensive industrial hardware during oil fueled fires. Typically, such fires are known to range for several hours at 1200 C (2190 F) and which are virtually impossible to put out, once they have started.

A typical design requirement is to have a panel survive a 35 psf (1676 N/m̂2) wind load during regular use conditions. Additionally it needs to survive a 15 psf (718 N/m̂2) wind load in combination with an oil fueled fire.

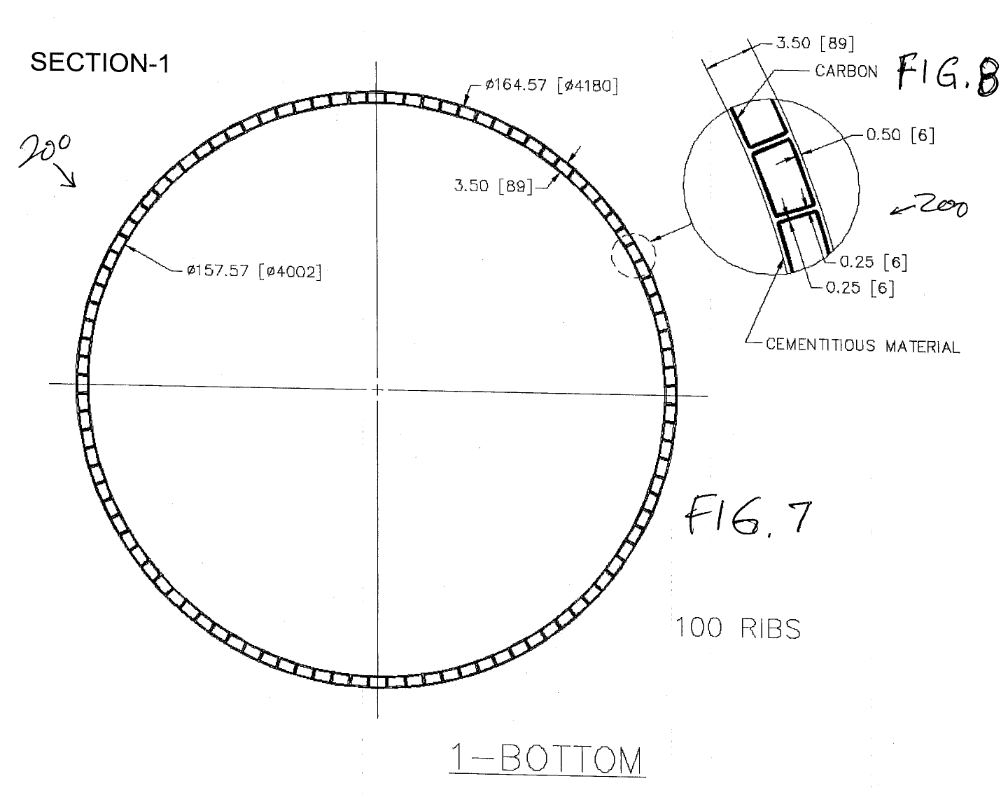

The combined requirement of impact resistance and heat resistance led to the idea of an open cell sandwich panel design as shown in FIG. 9.

The in-plane dimensions are 8.5′ (2.59 m) and 5′ (1.52 m) respectively and the panel weight is about 300 lbs (136 kg), allowing for flexibility and an easy modular approach, with light lifting equipment, to the installation and assembly of large structures.

The low 1509 psi (10.4 Mpa) stress level clarifies the survivability of this sandwich panel in adverse heat and fire exposure conditions.

During actual heat exposure there is a complex heat transfer phenomenon consisting of conduction, convection, and radiation. Given the 3.55″ (90.1 mm) thickness of the panel and its 12 open cells, there is slow heat penetration from the exposed side to the opposite side. The latter does not get any hotter than 260 C (500 F) after two hours of one-sided exposure to 1200 C (2190 F).

Full Scale Sandwich Panel Testing

Two types of full scale panel tests were performed. The first type was a concentrated load simulating the impact of debris due to explosion. The second was a uniformly distributed load, simulating wind forces. Both of these tests were performed on panels which are representative of production panels.

For the concentrated load test the sandwich panel was oriented horizontally and simple supported with a steel angle resting on top of the apex of the angle with a bearing width of two inches, a bridge test fixture consisting of steel members.

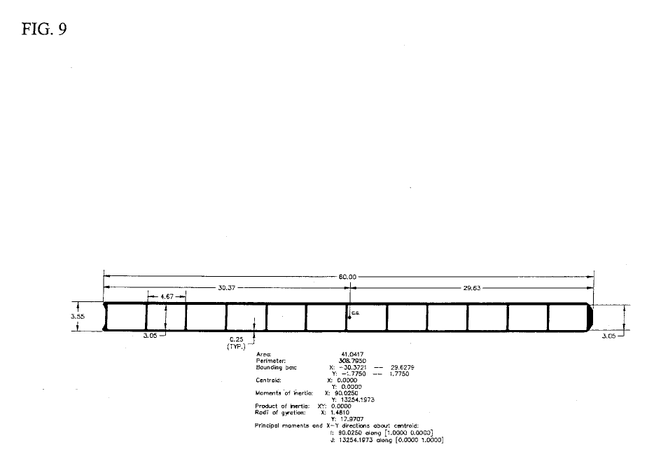

Secured to the test fixture, a 10-ton calibrated hydraulic ram was used to apply a compression load in the direction perpendicular to the surface of the test panel on top of a 1 foot by 1 foot (0.3 m×0.3 m) square and 1⅕″ inch thick steel plate located at the geometric center of the panel. A load cell was attached to the end of the ram piston to measure the applied loads. FIG. 10 is a load deflection plot which was obtained by steadily increasing the load at 900 lb/min (4090 N/min) until the sandwich panel failed.

The second type of test was a distributed load test for which is described in section 11.3.1.3of ASTM E 72. This method employs the use of a chamber and a vacuum pump to uniformly load the surface of the sandwich panel.

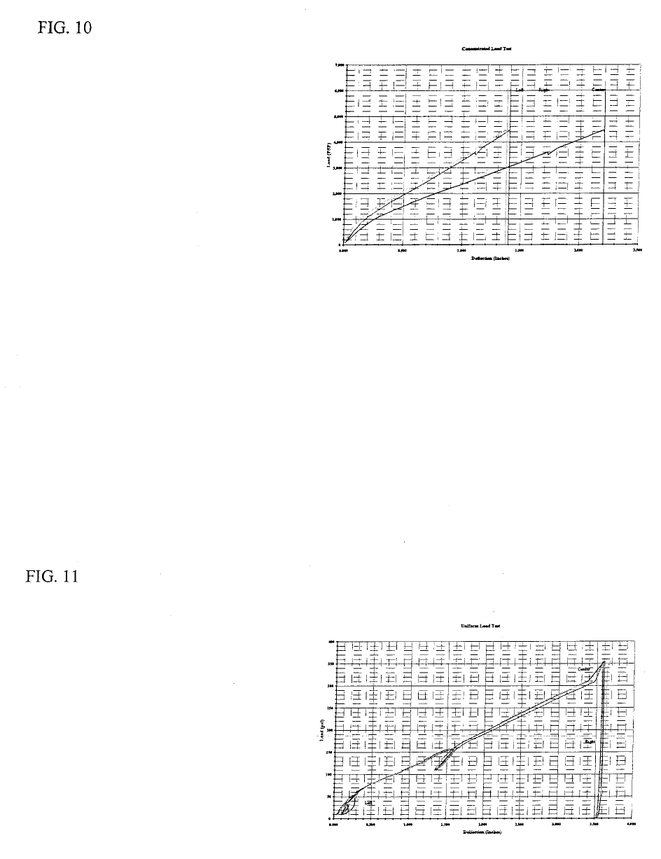

The panel was oriented and supported in the same way as for the concentrated load test. An airtight steel frame surrounded the panel closely about flush with the upper surface of the panel. Polyethylene sheeting covered the panel, and it was sealed so that is was reasonably airtight. A vacuum pump was used to reduce air pressure between the panel and the floor. The pressure was measured with a digital nanometer. As the vacuum was increased, the deflection was uniformly monitored as shown in FIG. 11. The hysteresis-loops which are shown are due to leakages which are sealed during the course of test.

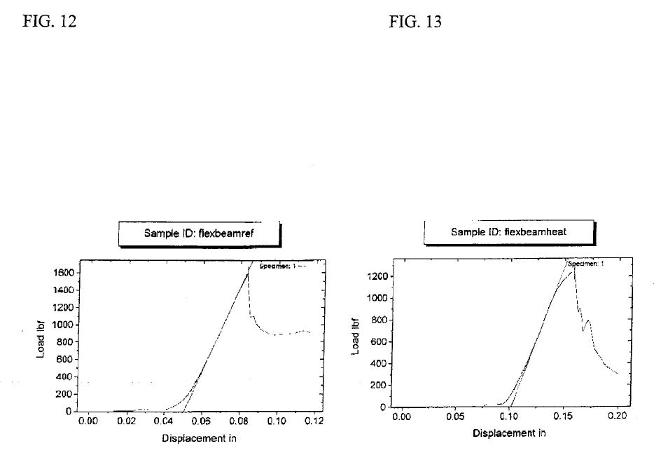

FIG. 12 represents a load deflection curves obtained, at room temperature, on a beam section of a production panel.

FIG. 13 is a result obtained on exactly the same configuration after exposure at 1200 C for two hours. The exposed panel section achieved 78% of the strength of a section which had never been exposed to heat.

Laboratory to Industrial Use

Specific test, design, and manufacturing steps are described to support the material of this disclosure for a high-performance-firewall which is capable of separating expensive industrial hardware, such as the 500 KV transformers during oil fueled fires.

These fires are known to range for several hours at 1200 C (2190 F) and which are virtually impossible to put out, once they have started. They need to be attacked with foam, which may not be readily available.

The installation and firewall construction design details may easily be determined by one of ordinary skill upon review of this specification.

The methods and products of the present disclosure find use in high temperature applications ranging from control surfaces for hypersonic vehicles on the high end to low-cost building materials on the low end. Application of design and process knowledge gained from the aerospace industries such as SAMPLE places materials as this in a position to replace high temperature polymers at a fraction of their cost.

All printed materials cited herein, including patents, patent applications; papers, publications, books, internet materials and the like, and all publications cited in any such materials cited herein, are herein incorporated by reference for all that they disclose and teach.

The present disclosure is to be taken as illustrative rather than as limiting the scope or nature of the claims below. Any number of embodiments may be obtained through the numerous modifications and variations which will become apparent to those skilled in the art after studying the disclosure, including use of equivalent functional and/or structural substitutes for elements described herein, use of equivalent functional couplings for couplings described herein, and/or use of equivalent functional actions for actions described herein. Such embodiments are to be considered within the scope of the claims below.

The scope of protection is defined by the claims appended hereto, and the scope of such claims is not intended nor is it limited by the above disclosure of general concepts and specific embodiments. The issued claims are not to be taken as limiting Applicant's right to claim disclosed, but not yet literally claimed subject matter by way of one or more further applications including those filed pursuant to the laws of the United States and/or international treaty.

What is claimed is:

1. A method comprising:
cooling at least one of a Wollastonite component or an acid component; and
contacting the Wollastonite component and the acid component to form a precursor for a chemically bonded ceramic.

2. The method of claim 1, wherein the acid component comprises aqueous phosphoric acid, and the Wollastonite component comprises a Wollastonite powder.

3. The method of claim 2 further comprising,
Curing the precursor to form a chemically bonded ceramic.

4. The method of claim 2 further comprising,
Cooling the precursor to form a cooled precursor; and
Curing the cooled precursor to form a chemically bonded ceramic.

5. The method of claim 2 further comprising,
Curing the mixture to form a chemically bonded ceramic; and
Cooling the precursor during at least a portion of the curing.

6. A method comprising the steps of
contacting a wollastonite component and an acid component to form a precursor; and
cooling the precursor.

7. The method of claim 6, wherein the acid component comprises aqueous phosphoric acid, and the Wollastonite component comprises a Wollastonite powder.

8. The method of claim 6 further comprising,
Curing the precursor to form a chemically bonded ceramic.

9. The method of claim 6 further comprising,
Curing the mixture to form a chemically bonded ceramic; and
Cooling the precursor during at least a portion of the curing.

10. A method comprising the steps of
contacting a wollastonite component and an acid component to form a precursor; and
cooling both the wollastonite component and the acid component during at least a portion of the contacting.

11. The method of claim 1I 0 wherein the acid component comprises aqueous phosphoric acid, and the Wollastonite component comprises a Wollastonite powder.

12. The method of claim 10 further comprising,
Curing the precursor to form a chemically bonded ceramic.

13. The method of claim 10 further comprising,
Curing the mixture to form a chemically bonded ceramic; and
Cooling the precursor during at least a portion of the curing.

14. A precursor for a chemically bonded ceramic comprising a wollastonite component and an acid component, wherein at least one of the components is cooled.

15. The precursor of claim 14, wherein the acid component comprises aqueous phosphoric acid, and the Wollastonite component comprises a Wollastonite powder.

16. The precursor of claim 15, wherein both components are cooled.

17. A method for making a composite structure, comprising the steps of:
applying a release layer to a mandrel;
applying a precursor material comprising a wollastonite component and an acid component to the release material;
curing the precursor material to form a cured ceramic; and
recovering the cured ceramic from mandrel.

18. A method for making a composite structure, comprising the steps of:
applying a precursor material comprising a wollastonite component and an acid component to the mandrel;
curing the precursor material to form a cured ceramic; and
recovering the cured ceramic from mandrel.

19. A product comprising:
a mandrel;
a release material supported on the mandrel;
precursor material supported by the release material on the mandrel;
wherein the precursor material comprises a wollastonite component and an acid component.

20. A product comprising:
a mandrel;
precursor material supported directly on the mandrel; wherein the precursor material comprises a wollastonite component and an acid component.

21. A product comprising:
a mandrel;
a release material supported on the mandrel; and
cured ceramic material supported by the release material or directly on the mandrel;
wherein the cured ceramic material is formed from a wollastonite component and an acid component.

22. A method for making a composite structure, comprising the steps of:
a) Forming a cooled precursor material comprising a wollastonite component and an acid component and applying to a woven or non-woven textile, knit or mat material;
b) wetting out and fully impregnating the fibrous material with the precursor while removing volatile gases and while optionally cooling the precursor as described in claim 6 and 7;
c) placing the precursor with fibrous reinforcement onto a molding surface that possesses good release characteristics;
d) curing the precursor material with fibrous reinforcement to form a cured ceramic; and,
e) recovering the cured fibrous reinforced ceramic part from the molding surface.

23. A product obtained by the process of:
a) Forming a cooled precursor material comprising a wollastonite component and an acid component and applying to a woven or non-woven textile, knit or mat material;
b) wetting out and fully impregnating the fibrous material with the precursor while removing volatile gases and while optionally cooling the precursor as described in claim 6 and 7;
c) placing the precursor with fibrous reinforcement onto a molding surface that possesses good release characteristics;
d) curing the precursor material with fibrous reinforcement to form a cured ceramic; and,
e) recovering the cured fibrous reinforced ceramic part from the molding surface.
